(19) United States
(12) Patent Application Publication
(10) Pub. No.: US 2017/0074812 A1
(43) Pub. Date: Mar. 16, 2017

(54) METHOD FOR DETERMINING A COEFFICIENT OF THERMAL LINEAR EXPANSION OF A MATERIAL AND A DEVICE FOR IMPLEMENTING THE SAME

(71) Applicant: SCHLUMBERGER TECHNOLOGY CORPORATION, Sugar Land, TX (US)

(72) Inventors: Sergey Sergeevich Safonov, Moscow (RU); Yury Anatolievich Popov, Moscow (RU); Anton Vladimirovich Parshin, Winchester (GB); Vladimir Viktorovich Abashkin, Moscow (RU)

(21) Appl. No.: 15/265,060

(22) Filed: Sep. 14, 2016

(30) Foreign Application Priority Data
Sep. 14, 2015 (RU) 2015139029

(51) Int. Cl. G01N 25/16; G01N 9/24

(52) U.S. Cl. CPC G01N 25/16; G01N 9/24

(57) ABSTRACT

Studies of mechanical and thermal properties of materials. The method for determining a CLTE coefficient of a material comprises moving relative to each other a sample of the material and a source of heating a surface of the sample. While moving, the surface of the sample is heated with a periodic change in a density of a heating power, and an amplitude of deformation of the sample surface by heating is measured. Coefficient of linear thermal expansion is calculated based on measurement results and taking into account a density and a volumetric heat capacity of the sample. A device for determining CLTE comprises a platform for placing a sample of a material, a heating source configured to change a density of a heating power, at least one sample surface deformation amplitude sensor and a system for relative movement of the sample, the heating source and the surface deformation amplitude sensors.

### CROSS-REFERENCE TO RELATED APPLICATION

This application claims priority to Russian Application No. 2015139029 filed Sep. 14, 2015, which is incorporated herein by reference in its entirety.

### BACKGROUND

The subject disclosure relates to studies of mechanical and thermal properties of materials.

Coefficient of linear thermal expansion (CLTE) is an important characteristic of a material, which combines thermal and mechanical properties of the material, especially in case of rocks that are promising reservoirs for recovery of hydrocarbons. Knowledge of CLTE is important for formation geomechanical modeling, design of hydraulic fracturing, and realization of thermal assisted methods of oil recovery.

CLTE is a critically important property of a solid body for solving the tasks of designing, materials science, quality control, petrophysical and geomechanical studies. Stationary methods are known for measuring CLTE by heating a test sample and then measuring a degree of deformation by means of optical interferometry, machine vision, x-ray diffraction, using strain gauges, capacitors with movable plates, or linear variable differential transformers (see, for example, ASTM D4535-08 Standard Test Methods for Measurement of Thermal Expansion of Rock Using Dilatometer, or R. Pott, R. Schefzykt, “Apparatus for measuring the thermal expansion of solids between 1.5 and 380K”, 1983 J. Phys. E: Sci. Instrum, 16, p. 444). While providing accurate results these methods for CLTE measurement have drawbacks such as the considerable time spent on the experiment (from one hour to days) and small allowable linear dimensions of a test sample (5-10 mm), which may lead to unreliable results in measuring CLTE of heterogeneous materials at a high volume thereof. Some of these CLTE measurement methods further impose requirements on the accuracy of manufacturing test samples—sides, perpendicular to which deformation measurements are taken, must be parallel.

To obtain reliable results in studying CLTE of inhomogeneous materials (such as rocks, construction materials, composite materials) by stationary methods, it is necessary to carry out tests on a representative set of samples, which requires the preparation of a sufficiently great number of samples. In addition, the existing stationary measurement methods are not able to perform continuous profiling of CLTE for each tested sample of heterogeneous materials, which impairs the reliability of the measurement results.

Transient methods for CLTE measurement and evaluation include a laser flash method (Heng, W., Guanhu, H., Benlian, Z., Xin, C., Wuming, L., “Noncontact flash method for measuring thermal expansion of foil specimens”, v. 64, No. 12, 1993, p. 3617-3619), and variants of photoacoustic methods (M. A. Proskurnin, M. Yu.Kononets , “Modern analytical thermooptical spectroscopy”, Russian Chemical Reviews 73, (12), pp. 1143-1172, 2004), including a method involving recording deflection of a laser beam reflected from a surface elastically deformed by heating, a method involving recording an intensity of acoustic signal from a periodically heated sample inside a gas-filled cell, and a method measuring the displacement of a locally heated surface by interferometric methods (U.S. Pat. No. 8,622,612).

Although the transient methods can significantly increase a measurement speed, the requirements on sample preparation remain rather strict similar to those in the stationary measurements of CLTE. A further common drawback of the transient methods for determining CLTE is that they require information about such properties of a test sample, as its volumetric heat capacity and bulk modulus.

### SUMMARY

The disclosure provides accuracy and efficiency of determining coefficient of linear thermal expansion of heterogeneous materials during transient heating of a surface of samples of the materials and acquiring at the same time data on elastic and thermal properties of the samples within the same measurement.

The disclosed method for determining a CLTE coefficient comprises moving relative to each other a sample of the material and a source of heating a surface of the sample. While moving, the surface of the sample is heated with a periodic change in a density of a heating power, and an amplitude of deformation of the sample surface by heating is measured. Coefficient of linear thermal expansion is calculated based on measurement results and taking into account a density and a volumetric heat capacity of the sample.

In accordance with an embodiment of the disclosure, while moving, a distance between the surface of the sample and the heating source is measured and, if necessary, the distance between them and/or a speed of their relative movement are adjusted.

In accordance with another embodiment of the disclosure, while moving, a surface profile of the sample is recorded.

In accordance with another embodiment of the disclosure, while moving, a frequency and an amplitude of change in a heating power are changed.

The heating source can be a local heating source, e.g. a laser, or a linear heating source. When a laser is used, a laser optical power and/or a focal length of a heating radiation focusing optical system is controlled. In another embodiment, an optical power of the laser remains constant, but a periodic change in the heating power density is provided by an optical radiation modulator.

While moving, a power of the heating source radiation reflected from the sample surface can be measured.

Furthermore, while moving, the density of the sample and its volumetric heat capacity can be measured.

The surface of the sample can be covered with a layer of a material absorbing the heating source radiation.

The measurement of the surface deformation amplitude can be carried out by a contactless method, for example, by fiber optic or electro-mechanical distance sensors.

The surface deformation amplitude during heating can be measured in several directions for recording a velocity profile of acoustic waves in the material.

A device for determining CLTE comprises: a platform for placing a sample of a material; a heating source configured to change a density of a heating power, and at least one sample surface deformation amplitude sensor. The device further comprises a system for relative movement of the sample, the heating source and the surface deformation amplitude sensors.

The device can further comprise a vibration-resistant optical table for disposing the platform.

The system for relative movement can be a biaxial positioning system capable of adjusting a distance between the heating source and the sample surface.

The device can further comprise means for varying a velocity of the relative movement of the heating source and the sample, and means for measuring the distance between the sample surface and the heating source.

The device can further comprise means for recording a profile of the sample surface.

The heating source can be a local heating source, for example, a laser. In this case, the device further comprises a laser radiation focusing unit to control the heating power density.

The heating source can be a linear heating source aligned in an arbitrary direction relative to a velocity vector of relative displacement of the sample and the heating source.

The device can further comprise means for measuring a power of the heating source radiation reflected from the sample surface.

The means for measuring the power of the heating source radiation reflected from the sample surface can comprise an integrating sphere with an internal coating capable of reflecting the heating source radiation, the sphere comprises detectors to register radiation at an operating wavelength of the heating source.

The device can further comprise means for recording a profile of the volumetric heat capacity of the sample, means for controlling an optical power of the laser and a geometry of the laser beam, and means for measuring the density of the sample.

### BRIEF DESCRIPTION OF DRAWINGS

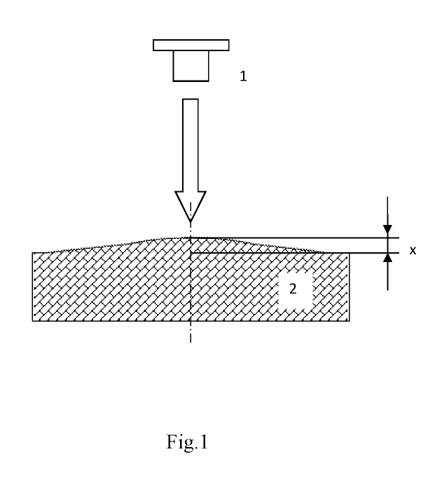

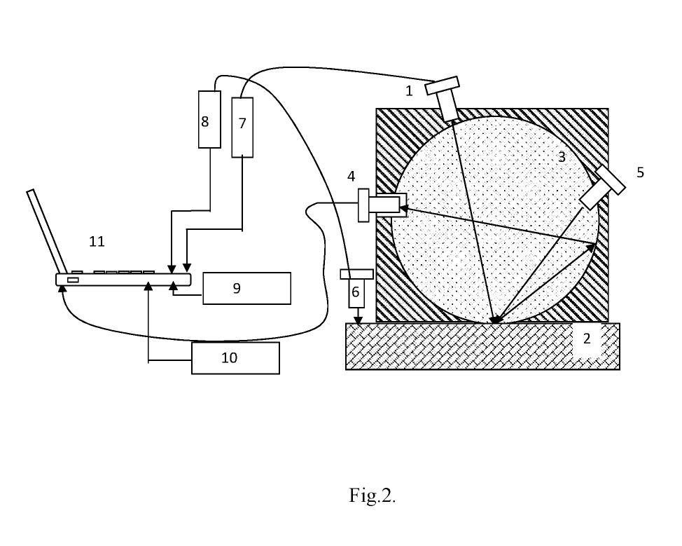

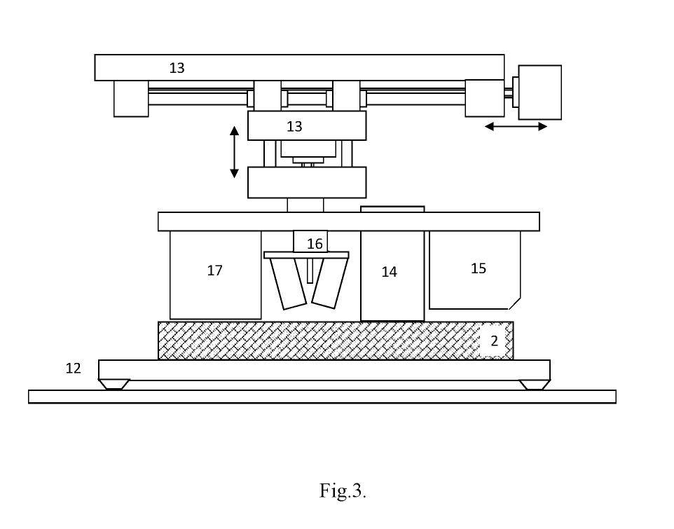

The disclosure is illustrated by drawings, where FIG. 1 shows a surface deformation of a sample of a material; FIG. 2 shows an example of a measuring circuit of the device, and FIG. 3 is a block diagram of a device for determining the coefficient of linear thermal expansion.

### DETAILED DESCRIPTION

For an isotropic solid body heated by a non-contact heating source with a density of a heating power changing according to a harmonic law, a dependence of a surface deformation amplitude on time can be precisely expressed using an absorbed power density value, values of the material bulk modulus, longitudinal and transverse wave velocities, CLTE, a thermal diffusivity, a volumetric heat capacity, and a density of the sample of the material.

The surface deformation amplitude x is a value characterizing a curvature of a surface of a locally heated sample, caused by thermal expansion of the material, as shown in FIG. 1, where 1 is a heating source with a variable power density, 2 is a sample of a material, and x is the surface deformation amplitude.

For example, for the case of impact on a surface by a heating source, which creates on the sample surface a heating line with a width a and a length much greater than the width, the dependence of /x/-modulus of the sample surface deformation amplitude, on properties of the material and an absorbed heating power density is expressed by the formula:

$$\vert x \vert = \frac{\sqrt{2}}{π} \frac{α B}{{( kC )}^{1 / 2}} {p}_{0} \frac{sin ( a \frac{{V}_{R}}{ω} )}{a \frac{{V}_{s}}{ω}} \frac{F}{{ω}^{3 / 2} {V}_{p}^{2}} \qquad ( 1 )$$

where α is CLTE of the sample, B is a bulk modulus of the sample, C is a volumetric heat capacity of the sample, V_{R} is a velocity of a surface acoustic Rayleigh wave, Vₚ is a velocity of a longitudinal compression wave, ω is a circular frequency of changing a heating source power, p₀ is a heating power density absorbed by the surface, k is a thermal conductivity of the material, F is the function that depends on thermal and elastic properties of the sample material.

When an optical heating source is used, a e wavelength is selected so that to minimize a radiation reflection or transmission losses of the sample material. For example, rocks are good at absorbing electromagnetic radiation with a wavelength of more than 8 microns, while radiation with wavelengths of 0.5-1 microns may be both reflected and transmitted through some rocks.

To ensure constant coefficients of absorption and reflection of the heating source radiation along the length of the sample, the surface of the sample can be coated with a material that absorbs the heating source radiation, for example, a thin metal film. In a case where the coating is impractical, the power density of the heating source radiation reflected from the sample surface is measured by sensors capable of detecting electromagnetic radiation at the operating wavelength of the heating source.

To ensure constant measurement results of the surface deformation amplitude along the length of the sample and the heating power density values on the sample surface, for samples with the surface non-parallel with the heating source-sample scanning direction it is necessary to record a profile of the sample surface.

The heating power density and a velocity of relative movement between the heating source and the sample are chosen to maximize a signal-to-noise ratio of the detected acoustic signal with account of maximum allowable temperatures for the material. So, for rocks in general it is undesirable to heat the sample surface above 70-80° C. In this case, for typical values of heating spot with the diameter of 1 mm and the scanning speed of 5 mm/s the heat source power should be 1-3 watts.

Relative movement between the sample and the heating source in the horizontal plane, and, if necessary, in the vertical plane may be accomplished using a positioning system consisting of guides (ball-screw pairs, guide rails, etc.) and electric motors that are used to provide movement along rails.

Due to small values of CLTE of rocks in comparison with those of metals and organic substances, sensors for measuring the deformation amplitude of the sample surface should have the measurements sensitivity not less than 1 micron.

To determine the CLTE of a material from the known dependence of the surface deformation amplitude on time, information is required about the bulk modulus, density and volumetric heat capacity of the material. Values of profiles of the above properties of rocks are obtained from the results of petrophysical investigations in boreholes, laboratory measurements on a representative set of samples of standard core, estimates of values of density, thermal and mechanical properties of the material by other known properties or by recording profiles of the above properties simultaneously with measurements of CLTE by scanning methods.

To implement CLTE measurements according to the disclosed method it is necessary to take into account the difference of space resolving power (SRP) of the methods used to record the profiles of physical quantities used for calculating CLTE. For example, the space resolving power limit (the smallest linear distance between two points of the sample, beginning from which the outgoing signals become invisible for an operator) has a gamma densitometry method—not less than 10 cm for measurements on a full-size rock core. The SRP limit for determining the volumetric heat capacity by an optical scanning method can reach 1 to 10 mm. SRP limits for means for determining roughness of the test sample surface and its optical properties can be less than 1 mm.

To implement the method of determining CLTE of a material a device shown in FIG. 2 and FIG. 3 can be used.

In accordance with one embodiment of the disclosure, means for measuring a power of radiation of a heating source 1, reflected from the surface of a sample 2 (FIG. 2), comprises an integrating sphere 3, a casing for mounting detectors (see, e.g., L. M. Hanssen, K. A. Snail, “Integrating Spheres for Mid—and Near-infrared Reflection Spectroscopy”, Handbook of Vibrational Spectroscopy ed. by J. M. Chalmers, P. R. Griffiths, John Wiley & Sons Ltd, Chichester, 2002, pp. 5, 10) with an inner coating capable of reflecting the radiation of a heating source 1, and detectors (photodiodes, bolometers) 4 capable of detecting radiation at an operating wavelength of the heating source, a laser, and designed to record the reflected radiation of the heating source 1.

An amplitude of surface deformation of the sample is recorded in a contactless manner by sensors 5, fiber optic or electromechanical distance sensors (FIG. 2). The surface deformation amplitude can be measured not only in the heating area, but also by the sensors 6 disposed outside of the integrating sphere 3 (FIG. 2), to determine a velocity of propagation of an acoustic wave in the material of the sample from the difference of arrival time of heating power and surface deformation amplitude signals.

The heating source 1 comprises a unit 7 (FIG. 2) for adjusting a frequency and an amplitude of change in the heating power according to a predetermined law, or in accordance with readings of means for measuring a power of radiation of the heating source 1, reflected from the sample 2 surface. The unit 7 can be, for example, a programmable driver including a laser pump current controller, a current sensor, a laser direct radiation power sensor, a laser temperature sensor, an amplifier, an adder, a discriminator, a device to input a control signal if the heating source is a semiconductor laser (see patent RU 2172514). Sample surface deformation amplitude sensors 5 also comprise a control unit 8, for example, comprising own laser radiation source, a photodiode, analog-to-digital converters, an oscilloscope, devices for input-output of optical power through fiber optic lines if fiber optic distance sensors are utilized (FIG. 2).

As shown in FIG. 2, the units 7 and 8 and unit 9 for processing signals of the unit for measuring the volumetric heat capacity (for example, described in Application WO2000043763 and including power sources of optical temperature sensors, an analog-to-digital converter of signals of the optical temperature meters, a unit for controlling power of own heat source), and unit 10 for processing signals of a density measurement unit are connected to a control computer 11 (FIG. 2) through which the operator controls the CLTE measurements.

As shown in FIG. 3, the device comprises a sample 2 on a sample platform 12 and a biaxial electromechanical positioning system 13 for adjusting a distance between the heating source with surface deformation amplitude sensors and the sample surface and relative movement thereof.

The heating source 1, reflected source radiation detectors 4 and surface deformation amplitude sensors 5 and 6 (shown in assembled state in FIG. 2) are accommodated in a unit 14 (FIG. 3) designed to determine a portion of reflected heating power. Units 7, 8, 9, and the control computer 11 are disposed separately and not shown in FIG. 3.

The device further comprises means 15 (FIG. 3) for recording a sample surface profile, a unit 16 (FIG. 3) for recording a sample volumetric heat capacity profile and a unit 17 (FIG. 3) for measuring the sample density.

To carry out the disclosed method, the surface of the sample 2 (FIG. 1, 2, 3) disposed on the platform 12 mounted on a vibration-resistant optical table (FIG. 3) is heated by the heating source 1 (FIG. 1, 2) configured to change a power density and allowing adjustment of a frequency and an amplitude of the power variation. When a laser is used as the heating source 1, it is required to control a heating power and a shape of the heating spot on the surface of the sample 2 of the material.

The unit 14 with the heating source 1 and the surface deformation amplitude sensors 5 and 6, and the surface of the sample 2 are moved (scanned) relative to each other by the biaxial positioning system 13 (FIG. 3). Since the heating power density may change due to change in the heating source-to-sample surface distance (for example, in a case of an uneven surface of the sample) the profile of the sample surface is recorded during the scanning process using the surface profile recording means 15 (FIG. 3), for example, a laser triangulation distance sensor or another device. Also while moving, the power of the heating source 1, reflected by the surface of the sample 2, is measured by the unit 14 (FIG. 3).

In accordance with an embodiment of the disclosure during the scanning process the volumetric heat capacity profile is recorded by an optical scanning method (see, e.g. Y. A. Popov, D. F. Pribnow, J. H. Sass, C. F. Williams and H. Burkhardt, “Characterization of rock thermal conductivity by high resolution optical scanning”, Geothermics, No. 28, p. 253-276, 1999) by the unit 16 (FIG. 3).

Furthermore, the biaxial positioning system 13 (FIG. 3) adjusts the relative position of sensors for measuring the surface deformation amplitude and the sample surface to provide a maximum signal-to-noise ratio of their signals.

In practice, measurements can be also taken of the sample density by the unit 17 (FIG. 3) operating on a gamma densitometry or neutron porosimetry principle (see e.g. ISS-01 “Multirad-GEO”. Installation for gamma-ray logging and density measurement of full-sized core. Registration No. in State Register CI No. 32716-06, Certificate RU. C.39.002.A No. 25263).

The operator sets the velocity of moving (scanning) and adjusts the distance between the heating source 1 and the surface of the sample 2, selects areas of the sample, in which the CLTE profile will be recorded.

Then, profiles of the surface reflection coefficient of the sample, its density and volumetric heat capacity are recorded. During the recording, the power density of heating the sample surface is periodically changed and the surface deformation amplitude sensors record the profile of variation of the amplitude of deformation of the heated portion of the surface of the sample material and velocities of propagation of acoustic wave in the material (for example, by determining a difference between the start time of the heating source and first arrival of signal at the sensor of deformation amplitude of the sample surface at a known distance between the heating point and the point of measuring the deformation amplitude of the sample surface). Power density can be changed, for example, on the sinusoidal law with a frequency determined with account of the fact that a sample thickness in the direction of propagation of a thermal wave induced by heating and thermal diffusivity of the sample is much greater than a characteristic length of the thermal wave of the material (kC/ω). For rock samples with the average thermal diffusivity of 10⁻⁶ m²·s⁻¹ and a sample thickness of about 1 mm, the preferred frequency of varying the heating power density should be above 10 Hz (see Guimarães, A. O., de Souza, C. G., da Silva, E. C., Soffner, M. E., Mansanares, A. M., Ribeiro, H. J. P. S., Carrasquilla, A. A. G., Vargas, H. “Thermal Diffusivity of Sandstone Using Photoacoustics (Article)”, International Journal of Thermophysics, Vol. 36, Issue 5-6, 22, June 2015, Pages 1093-1098).

Then coefficients of linear thermal expansion are calculated using formulas corresponding to the measurement organization scheme.

For example, when a linear source with a width a, or a laser forming on the sample surface a heating spot in the form of long stripe with width a is used, the calculations are performed by formula (1).

To enable measurements of CLTE by the disclosed method regular calibrations are required on a representative set of well-studied standard samples to account for systematic and random measurement errors.

1. A method for determining a coefficient of linear thermal expansion of a material, the method comprising:
moving relative to each other a sample of the material and a source of heating a surface of the sample;
while moving, heating the surface of the sample with periodic change in a density of a heating power, and measuring an amplitude of deformation of the surface of the sample as a result of said heating; and
calculating the coefficient of linear thermal expansion of the material based on results of the measurements taking into account a density and a volumetric heat capacity of the sample.

2. The method of claim 1, wherein while moving, a distance between the surface of the sample and the heating source is measured and, if necessary, the distance between them and/or a velocity of relative movement thereof are adjusted.

3. The method of claim 1, wherein while moving, a surface profile of the sample is recorded.

4. The method of claim 1, wherein while moving, a frequency and an amplitude of a change in the heating power are changed.

5. The method of claim 1, wherein the heating source is a laser.

6. The method of claim 1, wherein the heating source is a linear heating source.

7. The method of claim 5, wherein the periodic change in the density of the heating power is provided by an optical radiation modulator.

8. The method of claim 5, wherein a laser optical power and/or a focal length of a heating radiation focusing optical system is controlled.

9. The method of claim 1, wherein while moving, a power of the heating source radiation reflected from the sample surface is measured.

10. The method of claim 1, wherein while moving, the density of the sample is measured.

11. The method of claim 1, wherein while moving, the volumetric heat capacity of the sample is measured.

12. The method of claim 1, wherein the surface of the sample is covered with a layer of a material absorbing the heat source radiation.

13. The method of claim 1, wherein the measurement of the amplitude of the surface deformation is carried out by a contactless method.

14. The method of claim 13, wherein the measurement of the amplitude of the surface deformation is carried out by fiber optic or electro-mechanical distance sensors.

15. The method of claim 1, wherein the surface deformation amplitude during heating is measured in several directions for recording the velocity profile of acoustic waves in the material.

16. A device for determining a coefficient of linear thermal expansion of a material, comprising:
a platform for placing a sample of the material;
a heating source configured to change a density of a heating power;
at least one sensor of an amplitude of deformation of a surface of the sample, and a system for relative movement of the sample, the heating source and the sensors of the amplitude of the deformation of the surface of the sample.

17. The device of claim 16, further comprising a vibration-resistant optical table for disposing the platform.

18. The device of claim 16, wherein the system for relative movement is a biaxial positioning system configured to adjust a distance between the heating source and the surface of the sample.

19. The device of claim 16, further comprising means for changing a velocity of relative movement of the heating source and the sample.

20. The device of claim 16, further comprising means for measuring a distance between the surface of the sample and the heating source.

21. The device of claim 16, further comprising means for recording a profile of the surface of the sample.

22. The device of claim 16, wherein the heating source is a linear heating source aligned in an arbitrary direction relative to a velocity vector of the relative movement of the sample and the heating source.

23. The device of claim 16, wherein the heating source is a local heating source.

24. The device of claim 23, wherein the heating source is a laser.

25. The device of claim 24, further comprising a laser radiation focusing unit to control the heating power density.

26. The device of claim 24, further comprising a laser beam power and geometry control unit.

27. The device of claim 16, further comprising means for measuring a power of a heating source radiation reflected from the sample surface.

28. The device of claim 27, wherein the means for measuring the power of the heating source radiation reflected from the sample surface comprise an integrating sphere with an internal coating capable of reflecting radiation of the heating source, the sphere comprises detectors for registering radiation at a wavelength of the heating source.

29. The device of claim 16, further comprising means for recording a profile of the volumetric heat capacity.

30. The device of claim 16, further comprising a sample density measuring unit.

31. The device of claim 30, wherein the sample density measuring unit comprises means for gamma densitometry or neutron porosimetry.

32. The device of claim 30, further comprising electronic units for adjusting a space resolving power of the sample density measuring means.
